(19) United States
(12) Patent Application Publication
(10) Pub. No.: US 2011/0030429 A1
(43) Pub. Date: Feb. 10, 2011

(54) A CABLE THEFT PREVENTION DEVICE

(76) Inventor: Allan Cecil Goldring, Johannesburg (ZA)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/672,461

(22) PCT Filed: Jun. 13, 2008
(86) PCT No.: PCT/IB08/52334

§ 371 Date: Oct. 26, 2010

(30) Foreign Application Priority Data
Aug. 7, 2007 (ZA) 2007/06569

(51) Int. Cl. E05B 73/00; B65D 63/00

(52) U.S. Cl. 70/58

(57) ABSTRACT

A cable theft protection device for securing electricity supply cables or communications cables includes a body having an opening therethrough for receiving a cable. At least one engaging member extends away from the body to engage a material into which the cable and body are inserted thereby to prevent an unauthorized removal of the cable and body from the material.

### BACKGROUND OF THE INVENTION

THIS invention relates to a cable theft protection device, particularly for securing electricity supply cables or communications cables, for example.

Cable theft is a problem not only because the cable has to be replaced at great expense but in that it also results in a temporary loss of electricity supply with all its consequences. Cable theft also results in an unsafe environment as the parts of the cables that are not stolen are left exposed and are dangerous

Conventional cable theft occurs by cutting the cable at two spaced apart points and then pulling the cable out of the ground using a vehicle or rolling the cable onto a large rolling drum.

It is an object of this invention to address this

### SUMMARY OF THE INVENTION

According to the invention there is provided a cable theft prevention device comprising:
a body having an opening therethrough for receiving a cable; and
at least one engaging member extending away from the body to engage a material into which the cable and body are inserted thereby to prevent an unauthorized removal of the cable and body from the material.

Preferably, the body may comprise of at least two parts which are movable between an open position and a closed position, wherein when the parts are in the open position the cable can be inserted or removed from the opening and when the parts are in the closed position the cable is locked inside the body.

In an example embodiment, each body part may preferably be part-tubular with at least one body part having a greater spacing between major edges than the other body part such that edges or areas near the edges of the larger body part substantially overlap edges or areas near the edges of the other body part in the closed position.

The device may include at least one hinge connecting the first and second body parts to one another.

Advantageously, the body may include a locking formation for locking the at least two parts together. The locking formation may be a ring or hose clamp.

In one of the preferred embodiments, the body may be elongate having a longitudinal axis, wherein the engaging members extend from the body at an angle to the longitudinal axis.

Preferably, the device includes two engaging members located at two ends of the body. It will be appreciated that the engaging members may also move between an open position and a closed position.

The body may also have at least one cable engaging formation for holding the cable to prevent any movement of the cable within the body.

### BRIEF DESCRIPTION OF THE DRAWINGS

FIG. 1 shows a perspective view of a cable theft prevention device according to an example embodiment of the invention;

FIG. 2 shows a cable theft prevention device of FIG. 1 in an open position where the cable can be inserted or removed from the body;

FIGS. 3A to 3C show different cable engaging formations of the body;

FIG. 4 shows a side view of a cable theft prevention device with the cable inside and the material surrounding the device;

FIG. 5 shows a perspective view of another example embodiment of a cable theft prevention device;

FIG. 6 shows a side view of the cable theft prevention device of FIG. 5;

FIG. 7 shows a sectional view of the cable theft prevention device of FIG. 5 at 7-7;

FIG. 8 shows an exploded perspective view of another example embodiment of a cable theft prevention device;

FIG. 9 shows a perspective view of the cable theft prevention device of FIG. 8 with a cable inside; and

FIG. 10 shows a perspective view of an insert for use with a cable theft prevention device of any of the above embodiments.

### DESCRIPTION OF PREFERRED EMBODIMENTS

This invention relates to a cable theft prevention device. The cable theft prevention device is aimed, in particular, at the prevention of an unauthorized removal of the cable in the power distribution industry but could be used to secure any type of cable.

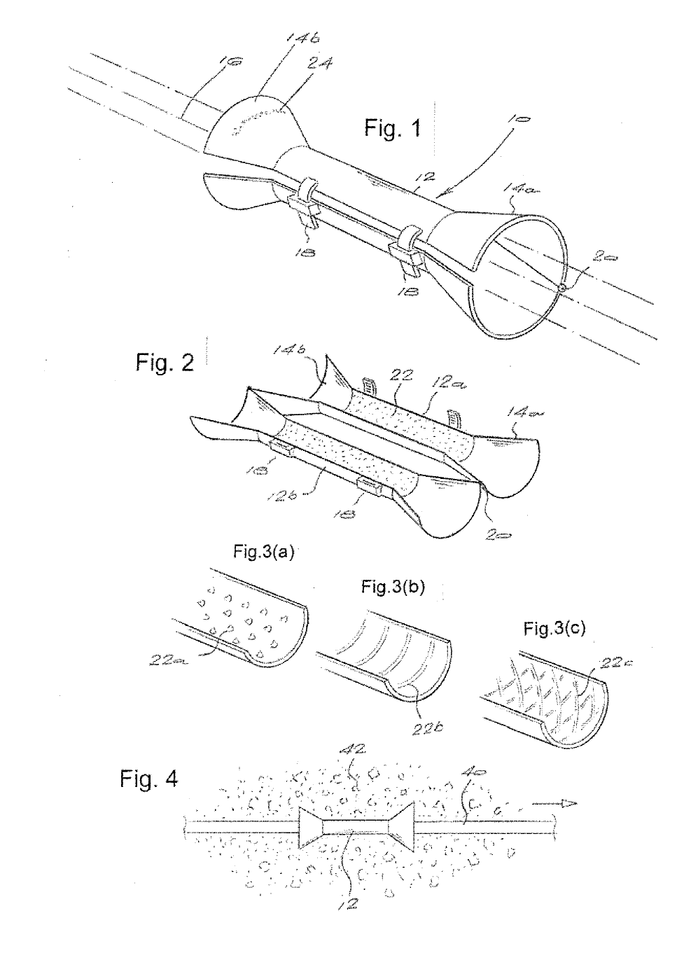

Referring to FIG. 1, an example embodiment of a cable theft prevention device 10 includes a body 12 having an opening therethrough for receiving a cable 40 (see FIG. 4).

At least one engaging member 14 extends away from the body 12 to engage a material 42 into which the cable 40 and body 12 are inserted thereby to prevent an unauthorized removal of the cable 40 and body 12 from the material 42 (see FIG. 4). This will be described in more detail below.

The illustrated embodiment includes two engaging members 14a and 14b, located on either side of the body 12.

The body 12 includes a longitudinal axis 16 and the engaging members 14a and 14b extend from the body 12 at an angle to the longitudinal axis 16.

In order to be useful the angle should be 90 degrees or less as will be appreciated with reference to the use of the device below.

In the illustrated embodiment, the body 12 includes a locking formation 18 for locking the cable 40 inside the body 12. The locking formation has been illustrated as two clips which are insertable into two openings. However, it will be appreciated that the locking formation could take any other suitable form. as will be seen in the further illustrated embodiments below which show other examples of locking formations.

In FIG. 2 the body 12 comprises of at least two parts and is generally denoted as 12a and 12b. The at least two parts 12a and 12b move from an open position to a closed position thereby to enable the insertion, removal and locking of the cable 40 into the body 12.

While still referring to FIG. 2 the body 12 includes a hinge 20 to connect the first and second body parts 12a and 12b together. While the hinge is illustrated located on the engaging members 14, in other embodiments the hinge could be located on the actual body itself.

The body 12 also has cable engaging formations 22 for holding the cable 40, thereby preventing any movement of the cable 40 within the body 12.

It will be appreciated from FIGS. 3A, 3B and 3C that the cable engaging formations 22 for holding the cable 40 are specifically made to properly engage with the cable 40, thereby to prevent any movement of the cable 40 within the body 12. However these cable engaging formations could take any form and the figures show only three possible examples of what the formations could look like.

In use, the two parts 12a and 12b of the body 12 are moved to an open position and the cable 40 is inserted inside the body 12 and locked within the body 12 using the locking formation 18. The cable is then laid with the device in place in the material 42 which is typically in soil. This is achieved by the cable installers digging a long trench, laying the cable in the trench and then covering the cable up with soil. Typically a number of these devices will be installed per length of cable.

It will be appreciated that when the cable is cut at two spaced apart points in order to be removed in an unauthorized manner, the engaging members 14 engage the material 42 surrounding the body 12 thus preventing the removal of the cable and the device 10.

For ease of use, there is a number 24 on the device 10 (see FIG. 1) so that the user can be guided as to the appropriate size of the cable 40 to be used with the specific device 10. The user selects a suitable size device for a cable 40 in order to allow the cable engaging formations 22 to hold the cable 40 tightly.

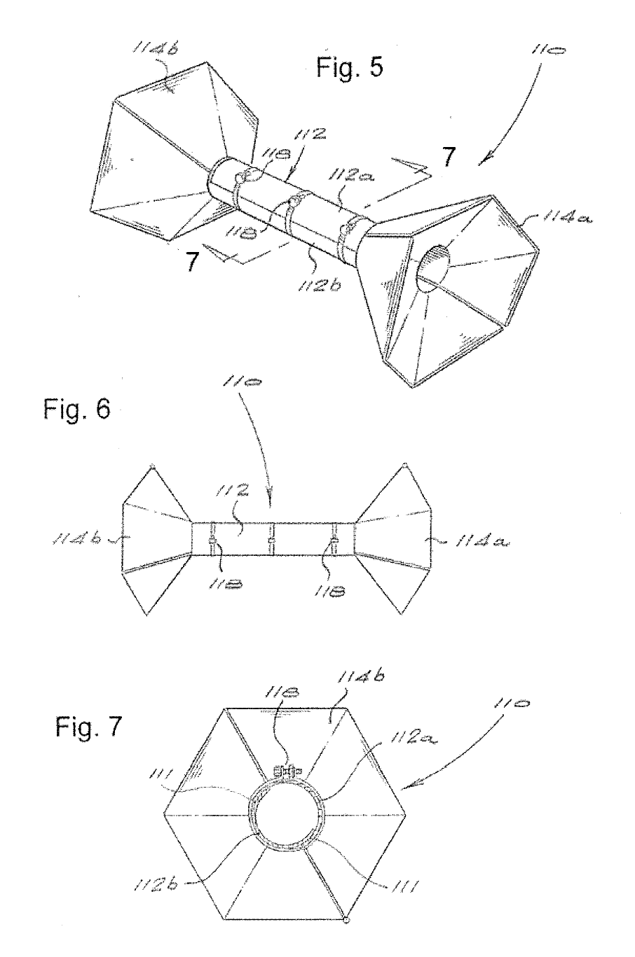

Referring now to FIGS. 5 to 7 of the drawings where another example embodiment of a cable theft prevention device is generally indicated by reference numeral 110.

The device 110 is similar to the device 10 of FIGS. 1 to 4 but differs in that it can be used for cables of different sizes or thickness as opposed to the user selecting a specific correct fit device for a particular cable.

The device 110 includes two body parts 112a and 112b which are movable between an open position and a closed position in a similar fashion as described above. However, in this embodiment, the one body part 112b is able to at least partially fit inside the other body part 112a so that the diameter of the opening through the body can be varied.

In the illustrated embodiment this is accomplished as the body part 112a has a greater spacing between its major edges 111 than the body part 112b. This allows the edges 111, or areas near the edges 111, to at least partially overlap edges or areas near the edges of the body part 112b. This is illustrated in FIG. 7.

It will be understood that the overlap configuration in the closed position allows the device 110 to accommodate cables of different or varying thickness. The body parts 112a and 112b are typically lockable in the closed position by way of a locking formation in the form of hose or ring clamps 118. A plurality of ring clamps 118 are advantageously disposed along the body 112 to lock the body 112 in the closed position. Other locking formations could also be used with this embodiment.

It will be appreciated that the respective portions of the engaging members 114a and 114b corresponding to the body parts 112a and 112b will also correspondingly overlap each other slightly. In this particular example embodiment, the engaging members 114a and 114b flare outwardly from the body 112 and typically have a hexagonal side profile, as can be see more clearly in FIGS. 5 and 7. However, the engaging members could take another shape such as the more rounded shape illustrated in FIG. 1 above, for example.

In use, the two parts 112a and 112b of the body 112 are moved to an open position and a cable 40 is inserted inside the body 112. The two parts 112a and 112b are then brought to the closed position where the edge 111 or the area near the edge 111 of the body part 112a overlaps the body part 112b to hold the cable snugly therein.

To lock the body parts 112a and 112b, with the cable therein, together, the user operates the ring clamps 118. The device 110 together with the cable therein is thereby inserted in the ground in a similar way as described above.

In operation, it will be noted that the device 110 operates or functions in a similar fashion as describes above with reference to the device 10.

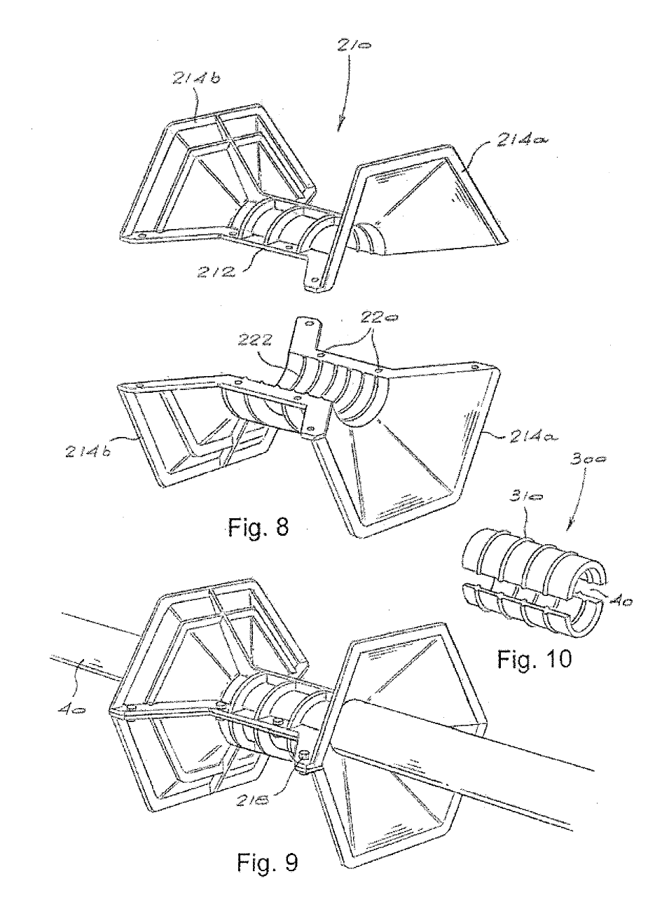

FIGS. 8 and 9 illustrate another embodiment. In this embodiment, the device 210 is illustrated at having two body parts which can be connected together using locking formations 218.

Each of the body parts has a plurality of holes 220 formed therein which are aligned with one another when the two body parts are placed together and through which bolts can be inserted. This can more easily be seen in FIG. 9.

It will be appreciated that, as mentioned above, other suitable locking formations 218 can be used with this embodiment.

In any event, the at least one engaging member 214 is comprised of hexagonal shapes 214a and 214b, part of which are located on the one body part and part of which are located on the other body part. Again it will be appreciated that other suitable shapes such as the round shape of FIG. 1, for example, could also be used.

In this embodiment, each half of the body 214 is located on either side of the cable 40 and bolts then secure the body parts together as can be seen in FIG. 9.

Referring to FIG. 10, in order to provide for any of the devices illustrated in any of the drawings and described above to be used with different sized cables, an insert 300 is provided which has outer engaging formations 310 that are shaped to engage with the formations 22 located inside the device. The insert then includes an opening therethrough for receiving the cable 40. Located inside the insert opening is cable engaging formations 322 to engage the cable. Various sized inserts can be provided with openings having different diameters so that for use with a cable of a particular diameter, an insert is selected that has an opening with a suitable diameter to receive the cable 40 securely therein.

The device in all of the above embodiments can be formed from any suitable material which allows ease of manufacture but has the necessary strength for the task. Examples of such materials would be metals or strong plastic materials.

1. A cable theft prevention device comprising:
a body having an opening therethrough for receiving a cable; and
at least one engaging member extending away from the body to engage a material into which the cable and body are inserted thereby to prevent an unauthorized removal of the cable and body from the material.

2. A cable theft prevention device as claimed in claim 1 wherein the body comprises at least two parts which are movable between an open position and a closed position, wherein when the parts are in the open position the cable can be inserted or removed from the opening and when the parts are in the closed position the cable is locked inside the body.

3. A cable theft prevention device as claimed in claim 2 wherein each body part is part-tubular with at least one body part having a greater spacing between major edges than the other body part such that edges or areas near the edges of the larger body part substantially overlap edges or areas near the edges of the other body part in the closed position.

4. A cable theft prevention device as claimed in claim 2 wherein the device includes at least one hinge connecting the first and second body parts to one another.

5. A cable theft prevention device as claimed in claim 2 wherein the body includes a locking formation for locking the at least two parts together.

6. A cable theft prevention device as claimed in claim 2 wherein the locking formation is a ring or hose clamp.

7. A cable theft prevention device as claimed in claim 1 wherein the body is elongate having a longitudinal axis, wherein the engaging members extend from the body at an angle to the longitudinal axis.

8. A cable theft prevention device as claimed in claim 1 wherein the device includes two engaging members located at two ends of the body.

9. A cable theft prevention device as claimed in claim 1 wherein the body includes at least one cable engaging formation for holding the cable to prevent any movement of the cable within the body.

10. A cable theft prevention device as claimed in claim 9 further including an insert comprising:
outer engaging formations that are shaped to engage with the cable engaging formations located inside the device;
an opening therethrough for receiving a cable; and
insert cable engaging formations located inside the insert opening to engage the cable.

11. A cable theft prevention device as claimed in claim 10 including a plurality of inserts having different diameters so that for use with a cable of a particular diameter an insert can be selected that has an opening with a suitable diameter to receive the cable securely therein.

12. A cable theft prevention device substantially as herein described with reference to the illustrated embodiments.

13. A cable theft prevention device as claimed in claim 1 wherein:
the body comprises an upper part and a lower part which are connectable to one another, each of the upper part and the lower part having a part of the opening formed therein so that when the upper part is connected to the lower part the opening through the body is formed, and further wherein the part of the opening in the upper part is sized to receive a portion of an insert therein and the part of the opening in the lower part is sized to receive a portion of an insert therein; and
an insert is comprised of an upper part and a lower part which are sized to be located in the part of the opening in the upper and lower parts of the body respectively, wherein each of the upper part and the lower part of the insert includes a part of an opening therethrough for receiving a cable and wherein cable engaging formations are located on an inside of the insert opening to engage the cable.

14. A cable theft prevention device as claimed in claim 13 wherein each of the body parts has a plurality of holes therein which are aligned with one another when the two body parts are placed together and which are used to secure the body parts to one another.

15. A cable theft prevention device as claimed in claim 14 further including bolts which are passed through the holes in the body parts to secure the body parts to one another.

16. A cable theft prevention device as claimed in any one of claims 13 to 15 including a plurality of inserts having different sized openings so that for use with a cable of a particular diameter an insert can be selected that has an opening with a suitable diameter to receive the cable securely therein.

17. A cable theft prevention device as claimed in any one of claims 13 to 15 wherein each of the insert parts has outer engaging formations that are shaped to engage formations located inside the device.
